(19) United States
(12) Patent Application Publication
(10) Pub. No.: US 2020/0190839 A1
(43) Pub. Date: Jun. 18, 2020

(54) REAL-TIME IDENTIFICATION METHOD FOR NONLINEAR CHARACTERISTIC OF MODEL-FREE IN-SERVICE SEISMIC ISOLATION/VIBRATION REDUCTION DEVICE

(71) Applicant: Xiamen University, Xiamen (CN)

(72) Inventors: Ying LEI, Xiamen (CN); Xiongjun YANG, Xiamen (CN); Ning YANG, Xiamen (CN); Han SU, Xiamen (CN)

(21) Appl. No.: 16/713,268

(22) Filed: Dec. 13, 2019

(30) Foreign Application Priority Data
Dec. 14, 2018 (CN) 201811533410.7

(51) Int. Cl. E04H 9/02; G06K 9/62; G06F 17/11; G06F 17/16

(52) U.S. Cl. CPC E04H 9/021; G06F 17/16; G06F 17/11; G06K 9/623

(57) ABSTRACT

The present disclosure provides a real-time identification method for a nonlinear characteristic of a model-free in-service seismic isolation/vibration reduction device. The method includes: dividing a structure of a seismic isolation/vibration reduction system into a plurality of substructures, and defining a substructure where the seismic isolation/vibration reduction device is located as a target substructure; and using a General Extended Kalman filter with unknown inputs (GEKF-UI) to identify a linear stiffness and a damping coefficient of the seismic isolation/vibration reduction device and a linear stiffness and a damping coefficient of the target substructure, in the case that an external excitation on the seismic isolation/vibration reduction device is small so that the seismic isolation/vibration reduction system is in a linear state.

### TECHNICAL FIELD

The present invention discloses a real-time identification method for a nonlinear characteristic of a model-free in-service seismic isolation/vibration reduction device driven based on monitoring data.

### BACKGROUND

Seismic isolation/vibration reduction devices and systems installed in engineering structures are of great significance to reduce the vibration and damage of the structures under the action of disasters such as earthquakes and strong winds, so as to improve the disaster prevention and mitigation capabilities of structural systems. As of now, there are approximately 3,600 seismic isolation structures and 430 vibration reduction structures in China, and the number is increasing rapidly year by year. At the same time, the research on seismic isolation/vibration reduction technologies and systems including passive control, semi-active control, active control, hybrid control, and intelligent control developed in recent years, and related engineering applications have developed rapidly. These control technologies and systems are dependent on the nonlinear dynamic characteristics of seismic isolation/vibration reduction devices. Commonly used seismic isolation/vibration reduction devices have been tested and determined for their dynamic performance and parameters before installation and use. However, because the seismic isolation/vibration reduction devices dissipate a lot vibration energy of the structure during the process of the structure's seismic isolation or energy dissipation and vibration reduction, they are the most vulnerable and sensitive part of the overall structure. Their performance is continuously degraded and fatigued under the long-term effects of loads, environment and other factors, and their nonlinear dynamic performance etc. will change throughout the life cycle. Therefore, their earlier laboratory test results are no longer applicable. In addition, with the development of science and technology, many new materials of seismic isolation/vibration reduction devices have appeared, and their nonlinear models are more complicated and difficult to determine. So far, there is little research on how to effectively identify the nonlinear dynamic characteristics of in-service seismic isolation/vibration reduction devices and systems in real time.

The existing technical methods for identifying the nonlinear characteristics of seismic isolation bearings/vibration dampers are mainly divided into two categories. One is to construct a nonlinear dynamic model of the seismic isolation/vibration reduction devices to identify the parameters of the model. So far, many types of models have been proposed. The other category is to approximate the difficult-to-model nonlinear restoring force characteristics of the seismic isolation/vibration reduction devices, which changes the problem of model-free identification into multi-series coefficient identification of an approximate model. However, as seismic isolation/vibration reduction devices are complicated nonlinear devices with varying dynamic performance, it is difficult to establish an accurate nonlinear model of seismic isolation/vibration reduction devices. Especially, it is difficult to truly reflect the performance changes of seismic isolation/vibration reduction devices installed in actual engineering structures over the entire life cycle. The multi-series approximate expansion of the nonlinear restoring force characteristics of seismic isolation/vibration reduction devices is subjective in the selection of a generating function and the number of terms in the series expansion. Existing research results have shown that such technical methods can cause a large error in the identification results. In addition, nonlinear characteristic identification methods based on time-frequency analysis techniques such as wavelet multi-scale analysis also have problems, for example, complicated calculations, delayed identification, and the need for an overall structure response to obtain monitoring data, etc. Therefore, they are also difficult to meet the actual needs of engineering.

In addition, many different types of seismic isolation bearings or vibration dampers are often installed in actual engineering structures. The structures' vibration reduction is the combined effect of various types of seismic isolation/vibration reduction devices. Therefore, if the analysis based on the monitoring data of the overall structure response, it is difficult to separately identify the nonlinear characteristics of different types of in-service seismic isolation bearings or vibration dampers in the structure.

### SUMMARY

In order to solve at least one of the above problems in the prior art, the present disclosure provides a real-time identification method for a nonlinear characteristic of a model-free in-service seismic isolation/vibration reduction device driven based on monitoring data.

According to an aspect of the present disclosure, a real-time identification method for a nonlinear characteristic of an in-service seismic isolation/vibration reduction device, including: dividing a structure of a seismic isolation/vibration reduction system into a plurality of substructures, and defining a substructure where the seismic isolation/vibration reduction device is located as a target substructure; and using a General Extended Kalman filter with unknown inputs (GEKF-UI) to identify a linear stiffness and a damping coefficient of the seismic isolation/vibration reduction device and a linear stiffness and a damping coefficient of the target substructure, in the case that an external excitation on the seismic isolation/vibration reduction device is small so that the seismic isolation/vibration reduction system is in a linear state. According to at least one implementation of the present disclosure, the method further includes: using a General Kalman filter with unknown inputs (GKF-UI) to identify a nonlinear restoring force received by the target substructure by the linear stiffness and the damping coefficient of the seismic isolation/vibration reduction device and the linear stiffness and the damping coefficient of the target substructure, in the case that the external excitation on the seismic isolation/vibration reduction device is large so that the seismic isolation/vibration reduction device generates a nonlinear force.

According to at least one implementation of the present disclosure, in the case that the external excitation on the seismic isolation/vibration reduction device is small so that the seismic isolation/vibration reduction system is in a linear state, a motion equation of the target substructure is:

M^{r}\ddot{x}^{r}(t)+(C^{r}+C′)\dot{x}^{r}(t)+(K^{r}+K′)x^{r}(t)=η^{r}f^{r}(t)+η^{g}f^{g}(t)=η^{u}f^{u}(t)

where, M^{r}, Cᵣ and K^{r} are mass, damping and stiffness matrices of the target substructure, respectively; \hat{x}^{r}(t), \dot{x}^{r}(t) and x^{r}(t) are acceleration, velocity and displacement vectors of the target substructure, respectively; f^{r}(t) is the external excitation received by the target substructure; f^{g}(t) is a force of an adjacent substructure on the target substructure; η^{r} and η^{g} are position matrices of the external excitation and the force; C′ and K′ are additional damping and stiffness provided by the seismic isolation/vibration reduction device to the system structure; η^{u} is a position matrix of the external excitation f^{u}(t) According to at least one implementation of the present disclosure, in the case that the external excitation on the seismic isolation/vibration reduction device is small so that the seismic isolation/vibration reduction system is in a linear state, an extended vector Z=[x^{T} \dot{x}^{T} θ^{T}]^{T} is established, and the GEKF-UI is used to obtain θ to express the linear stiffness and the damping coefficient of the seismic isolation/vibration reduction device and the linear stiffness and the damping coefficient of the target substructure.

According to at least one implementation of the present disclosure, in the case that the external excitation on the seismic isolation/vibration reduction device is large so that the seismic isolation/vibration reduction device generates a nonlinear force, a motion equation of the target substructure is:

M^{r}\ddot{x}^{r}(t)+C^{r}\dot{x}^{r}(t)+K^{r}x^{r}(t)=η^{r}f^{r}(t)+η^{g}g^{r}(t)−η^{non}f^{non}(t)=η^{u}f^{u}(t)

where C^{r} and K^{r} are identified values in the case that the external excitation on the seismic isolation/vibration reduction device is small so that the seismic isolation/vibration reduction system is in a linear state.

According to at least one implementation of the present disclosure, the GKF-UI is used to identify f^{u}(t) by observing a response of a partial structure.

According to at least one implementation of the present disclosure, the nonlinear force generated by the vibration reduction/seismic isolation device is identified based on the identified f^{u}(t) and f^{u}=[f^{r}(t) g^{r}(t) f^{non}(t)]^{T}.

According to another aspect of the present disclosure, a real-time identification device for a nonlinear characteristic of an in-service seismic isolation/vibration reduction device, including:

a dividing module, for dividing a structure of a seismic isolation/vibration reduction system into a plurality of substructures, and defining a substructure where the seismic isolation/vibration reduction device is located as a target substructure; and

a GEKF-UI identification module, for using a GEKF-UI to identify a linear stiffness and a damping coefficient of the seismic isolation/vibration reduction device and a linear stiffness and a damping coefficient of the target substructure, in the case that an external excitation on the seismic isolation/vibration reduction device is small so that the seismic isolation/vibration reduction system is in a linear state.

According to at least one implementation of the present disclosure, the device further includes: a GKF-UI identification module, for using a GKF-UI to identify a nonlinear restoring force received by the target substructure, the external excitation and an interaction force between the substructures by the linear stiffness and the damping coefficient of the seismic isolation/vibration reduction device and the linear stiffness and the damping coefficient of the target substructure identified by the GEKF-UI identification module, in the case that the external excitation on the seismic isolation/vibration reduction device is large so that the seismic isolation/vibration reduction device generates a nonlinear force.

According to at least one implementation of the present disclosure, in the case that the external excitation on the seismic isolation/vibration reduction device is small so that the seismic isolation/vibration reduction system is in a linear state, a motion equation of the target substructure is:

M^{r}\ddot{x}^{r}(t)+(C^{r}+C′)\dot{x}^{r}(t)+(K^{r}+K′)x^{r}(t)=η^{r}f^{r}(t)+η^{g}f^{g}(t)=η^{u}f^{u}(t)

where, M^{r}, C^{r} and K^{r} are mass, damping and stiffness matrices of the target substructure, respectively; \ddot{x}^{r}(t), \dot{x}^{r}(t) and x^{r}(t) are acceleration, velocity and displacement vectors of the target substructure, respectively; f^{r}(t) is the external excitation received by the target substructure; f^{g}(t) is a force of an adjacent substructure on the target substructure; η^{r} and η^{g} are position matrices of the external excitation and the force; C′ and K′ are additional damping and stiffness provided by the seismic isolation/vibration reduction device to the system structure; η^{u} is a position matrix of the external excitation f^{u} (t); an extended vector Z=[x^{T} \dot{x}^{T} θ^{R}]^{T} is established, and the GEKF-UI is used to obtain θ to express the linear stiffness and the damping coefficient of the seismic isolation/vibration reduction device and the linear stiffness and the damping coefficient of the target substructure.

In the case that the external excitation on the seismic isolation/vibration reduction device is large so that the seismic isolation/vibration reduction device generates a nonlinear force, a motion equation of the target substructure is:

M^{r}\ddot{x}^{r}(t)+C^{r}\dot{x}^{r}(t)+K^{r}x^{r}(t)=η^{r}f^{r}(t)+η^{g}g^{r}(t)−η^{non}f^{non}(t)=η^{u}f^{u}(t)

where C^{r} and K^{r} are identified values in the case that the external excitation on the seismic isolation/vibration reduction device is small so that the seismic isolation/vibration reduction system is in a linear state.

The GKF-UI is used to identify f^{u}(t) by observing a response of a partial structure. The nonlinear force generated by the vibration reduction/seismic isolation device is identified based on the identified f^{u}(t) and f^{u}=[f^{r}(t) g^{r}(t) f^{non}(t)]^{T}.

### BRIEF DESCRIPTION OF THE DRAWINGS

The accompanying drawings illustrate exemplary implementations of the disclosure, and are intended to explain the principles of the disclosure together with the description thereof. The accompanying drawings are included to provide a further understanding of the disclosure, and are included in and constitute part of the specification.

FIG. 1 shows substructure division of a frame equipped with a seismic isolation device.

FIG. 2 shows substructure division of a frame equipped with a vibration reduction device.

FIG. 3 shows a comparison of numerical results of nonlinear force identification of a seismic isolation device.

FIG. 4 shows a comparison of numerical results of nonlinear force identification of a vibration reduction device.

FIG. 5 shows a comparison of experimental results of hysteresis loop identification of a nonlinear force of a negative stiffness damper (NSD).

FIG. 6 shows a comparison of experimental results of nonlinear force identification of a vibration reduction device.

### DETAILED DESCRIPTION

The present invention is described in further detail below with reference to the accompanying drawings and implementations. It should be understood that the specific implementations described herein are merely intended to explain related content, rather than to limit the present disclosure. It should also be noted that, for convenience of description, only the parts related to the present disclosure are shown in the accompany drawings.

It should be noted that, in case of no conflict, the implementations in the present disclosure and the features in the implementations may be combined with each other. The present disclosure is described in detail below with reference to the accompanying drawings and implementations.

The present disclosure provides a real-time identification method for a nonlinear characteristic of a model-free in-service seismic isolation/vibration reduction device driven based on monitoring data.

The method may include the following steps. Step 1: in case an external excitation on the seismic isolation/vibration reduction device is small, an entire seismic isolation/vibration reduction system is in a linear state; at this time, the seismic isolation/vibration reduction device only provides a linear restoring force; a system structure is divided into a plurality of substructures, and a target substructure where the seismic isolation/vibration reduction device is located is defined as a target substrate for analysis; a General Extended Kalman filter with unknown inputs (GEKF-UI) is used to identify a linear stiffness and a damping coefficient of the seismic isolation/vibration reduction device and a linear stiffness and a damping coefficient of the target substructure. Step 2: under a large external excitation, the seismic isolation/vibration reduction device generates a nonlinear force, and the system structure is still in a linear state; the nonlinear restoring force generated by the seismic isolation/vibration reduction device is regarded as an unknown “additional virtual force” applied to the target substructure; the target substructure is analyzed; the target substructure is subject to the nonlinear restoring force, the external excitation and an interaction force between the substructures. a General Kalman filter with unknown inputs (GKF-UI) is used to identify the nonlinear restoring force, the external excitation and the interaction force between the substructures.

In this way, the method proposed by the present disclosure only observes a response of a partial structure, and is applicable regardless whether an acceleration response is observed at an action position of the nonlinear force, an action position of the seismic isolation/vibration reduction device and a connection position between the substructures.

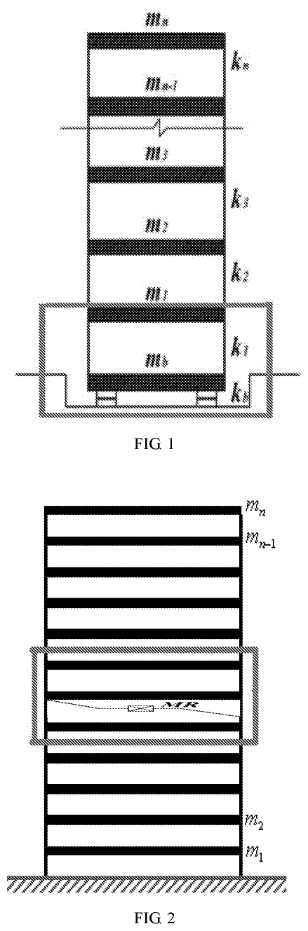

A frame structure is taken as an example. FIG. 1 shows substructure division of a frame equipped with a seismic isolation device, and FIG. 2 shows substructure division of a frame equipped with a vibration reduction device. Due to substructure division, a substructure is separated from an overall structure. For example, an r-th substructure is separated from the overall structure. The substructure is affected by a force from other substructures where the substructure is connected to other substructures. Therefore, the r-th substructure is taken out for parameter identification, and an interaction force between the substructures is unknown. A motion equation of the substructure is:

M^{r}\ddot{x}^{r}(t)+C^{r}\dot{x}^{r}(t)+K^{r}x^{r}(t)+η^{non}f^{non}(t)=η^{r}f^{r}(t)+η^{g}f^{g}(t) (1)

where, M^{r}, C^{r} and K^{r} are mass, damping and stiffness matrices of the r-th substructure, respectively; \ddot{x}^{r}(t), \dot{x}^{r}(t) and x^{r}(t) are acceleration, velocity and displacement vectors of the r-th substructure, respectively; f^{non}(t) is a restoring force provided by the seismic isolation/vibration reduction device; f^{r}(t) is an external excitation received by the r-th substructure; f^{g}(t) is a force of an adjacent substructure on a target substructure (the r-th substructure); η^{non}, η^{r} and η^{g} are corresponding position matrices of the restoring force, the external excitation and the force.

A seismic isolation/vibration reduction device installed in a large structure will generate a nonlinear force under a large external excitation. For a locally nonlinear structure, substructures including a substructure where the seismic isolation/vibration reduction device is located are regarded as target substructures, and the target sub-structures are separately nonlinearly identified. In this way, the identification efficiency is greatly improved.

When the external excitation is small, the seismic isolation/vibration reduction device is in a linear state. f^{non}(t) is a linear restoring force, which means that the seismic isolation/vibration reduction device provides additional stiffness and damping to the structure. The motion equation (1) can be:

M^{r}\ddot{x}^{r}(t)+(C^{r}+C′)\dot{x}^{r}(t)+(K^{r}+K′)x^{r}(t)=η^{r}f^{r}(t)+η^{g}f^{g}(t)=η^{u}f^{u}(t) (2)

where, C′ and K′ are the additional stiffness and damping provided by the seismic isolation/vibration reduction device to the structure, respectively.

An extended state vector

$${H}_{k + 1 \vert k} = \frac{\partial \overline{h} ( Z )}{\partial {Z}^{T}} {\vert}_{Z = {\tilde{Z}}_{k + 1 \vert k}}$$

is established:

$$\dot{Z} = [ \begin{matrix}\dot{x} \\ \ddot{x} \\ \dot{θ}\end{matrix} ] = [ \begin{matrix}\dot{x} \\ {( {M}^{r} )}^{- 1} ( - ( {K}^{r} + {K}^{′} ) - ( {C}^{r} + {C}^{′} ) \dot{x} + {η}^{u} {f}^{u} ) \\ 0\end{matrix} ] = \overline{g} ( Z ) + \overline{B} {f}^{u} \qquad ( 3 )$$

where, g̅(·) represents a nonlinear function, B̅=[0 (M^{r})⁻¹η^{u} 0]^{T}, and θ represents a structural parameter.

A supplementary observation equation is as follows:

y=h̅(Z)+Df^{u} (4)

where, h̅(·) represents a nonlinear function, and D represents a position influence matrix of a known external excitation f^{u}.

A first-order Taylor expansion is performed on g̅(Z) and h̅(Z).

g̅(Z)=g̅(\hat{Z}_{k|k})+G_{k|k}(Z−\hat{Z}_{k|k}) (5)

h̅(Z)=h̅(\tilde{Z}_{k+1|k})+H_{k+1|k}(Z−\tilde{Z}_{k+1|k}) (6)

where,

$${G}_{k \vert k} = \frac{\partial \overline{g} ( Z )}{\partial {Z}^{T}} {\vert}_{Z = {\hat{Z}}_{k \vert k}} , {H}_{k + 1 \vert k} = \frac{\partial \overline{h} ( Z )}{\partial {Z}^{T}} {\vert}_{Z = {\tilde{Z}}_{k + 1 \vert k}} ,$$

\tilde{Z}_{k|k} represents an optimal state estimation at time k, and \tilde{Z}_{k+1|k} represents a state forecast at time k+1.

\tilde{Z}_{k+1|k}Aₖ\hat{Z}_{k|k}+Bₖ*\hat{f}_{k|k}^{u}+g_{k|k} (7)

where, Aₖ is a state-transition matrix, Bₖ*=(Aₖ−I) (G_{k|k}Δt)⁻¹ (B̅Δt) g_{k|k}=[g̅(\hat{Z}_{k|k})−G_{k|k}\hat{Z}_{k|k}]Δt.

Assuming that the external excitation f^{u} adopts first-order hold (FOH dispersion) in a sampling interval, the state equation and the observation equation are discretized as follows:

Zₖ₊₁=AₖZₖ+Bₖfₖ^{u}+Bₖ₊₁fₖ₊₁^{u}+g_{k|k}+wₖ (8)

yₖ₊₁=H_{k+1|k}Zₖ₊₁+h̅(\tilde{Z}_{k+1|k})−H_{k+1|k}\tilde{Z}_{k+1|k}+Dfₖ₊₁^{u}+vₖ₊₁ (9)

where, Zₖ₊₁ is a state vector at time k+1; Zₖ is a state vector at time k, Bₖ=½B̅Δt, Bₖ₊₁=½BΔt; fₖ^{u} is an unknown external excitation at time k; fₖ₊₁^{u} is an unknown external excitation at time k+1; wₖ is a model error, with a mean of 0 and a covariance of Qₖ; uₖ₊₁ is an observation vector at time k+1; vₖ₊₁ is a measurement error, with a mean of 0 and a variance of Rₖ₊₁.

An optimal state estimation at time k+1 is:

\hat{Z}_{k+1|k+1}=Z̅_{k+1|k}+Kₖ₊₁(yₖ₊₁−H_{k+1|k}Z̅_{k+1|k}−D\hat{f}_{k+1|k+1}^{u}−h_{k+1|k}) (10)

where, h_{k+1|k}=h̅(\tilde{Z}_{k+1|k})−H_{k+1|k}\tilde{Z}_{k+1|k} (11)

Z̅_{k+1|k}Aₖ\hat{Z}_{k|k}+Bₖ\hat{f}_{k|k}^{u}Bₖ₊₁+\hat{f}_{k+1|k+1}^{u}+g_{k|k} (12)

where, Kₖ₊₁ is a Kalman gain matrix;

$$\begin{matrix}{K}_{k + 1} = {{P}^{⋒}}_{k + 1 \vert k}^{Z} {{H}_{k + 1 \vert k}^{T} ( {H}_{k + 1 \vert k} {\overline{P}}_{k + 1 \vert k}^{Z} {H}_{k + 1 \vert k}^{T} + {R}_{k + 1} )}^{- 1} & ( 13 ) \\ {{P}^{⋒}}_{k + 1 \vert k}^{Z} = [ \begin{matrix}{A}_{k} & {B}_{k}\end{matrix} ] [ \begin{matrix}{\hat{P}}_{k \vert k}^{Z} & {\hat{P}}_{k \vert k}^{Zf} \\ {\hat{P}}_{k \vert k}^{fZ} & {\hat{P}}_{k \vert k}^{f}\end{matrix} ] [ \begin{matrix}{A}_{k}^{T} \\ {B}_{k}^{T}\end{matrix} ] + {Q}_{k} & ( 14 )\end{matrix}$$

By minimizing the error vector, an unknown external excitation \hat{f}_{k+1|k+1}^{u} is obtained:

\hat{f}_{k+1|k+1}^{u}=Sₖ₊₁[yₖ₊₁−H_{k+1|k}(Aₖ\hat{Z}_{k|k}+Bₖ\hat{f}_{k|k}^{u}g_{k|k})−h_{k+1|k}] (15)

where

Sₖ₊₁=(H_{k+1|k}Bₖ₊₁+D)^{T}Rₖ₊₁⁻¹(I−H_{k+1|k}Kₖ₊₁)(H_{k+1|k}Bₖ₊₁D)⁻¹(Hₖ₊₁Bₖ₊₁D)^{T}Rₖ₊₁⁻¹(I−H_{k+1|k}Kₖ₊₁ (16)

By observing a partial response, the GEKF-UI method identifies the unknown external excitation, the interaction force between the substructures and the extended vector Z=[x^{T} \dot{x}^{T} θ^{T}]^{T}, where θ represents the linear stiffness and the damping coefficient of the seismic isolation/vibration reduction device and the linear stiffness and the damping coefficient of the target substructure. These physical coefficients identified will be used in step 2.

The GKF-UI method is similar to the GEKF-UI method, except that the GKF-UI method is used with a known structural parameter. When the external excitation is large, the seismic isolation/vibration reduction device generates a nonlinear force. The nonlinear force provided by the seismic isolation/vibration reduction device is introduced to the right of the equation to form an unknown “additional virtual force”, and the equation (1) is rewritten as:

M^{r}\ddot{x}^{r}(t)+C^{r}\dot{x}^{r}(t)+K^{r}x^{r}(t)=η^{r}f^{r}(t)+η^{g}g^{r}(t)−η^{non}f^{non}(t)=η^{u}f^{u}(t) (17)

where, C^{r} and K^{r} are the values identified by the GEKF-UI in step 1. In order to overcome the limit of observing a response at an excitation point, as in the previous section, assuming that the unknown external excitation f^{u} adopts FOH in the sampling interval, the motion equation is discretized into the following form:

Xₖ₊₁=AₖXₖ+Bₖfₖ^{u}+Gₖ₊₁fₖ₊₁^{u}wₖ (18)

where, Xₖ₊₁ and Xₖ are state vectors of time t=(k+1) Δt, kΔt, respectively; Δt is a sampling time interval; Aₖ is a state-transition matrix; Bₖ and Gₖ₊₁ are influence matrices of an unknown force. wₖ is a model error, with a mean of 0 and a covariance of Qₖ.

By observing only the partial structure response, the discretized observation equation can be expressed as:

yₖ₊₁=Cₖ₊₁Xₖ₊₁+Hₖ₊₁^{u}fₖ₊₁^{u}+bₖ₊₁ (19)

where, yₖ₊₁ is an observation vector; Cₖ₊₁ is a state observation matrix; Hₖ₊₁^{u} is an observation matrix of an unknown force fₖ₊₁^{u}; vₖ₊₁ is an observation noise vector, with a mean of 0 and a covariance of Rₖ₊₁.

A state forecast equation and a state estimation equation are established as follows:

\tilde{X}_{k+1|k}=Aₖ\hat{X}_{k|k}+Bₖ\hat{f}_{k|k}^{u}Gₖ₊₁\hat{f}_{k+1|k+1}^{u} (20)

\hat{X}_{x+1|k+1}=\tilde{X}_{k+1|k}+Kₖ₊₁(yₖ₊₁−Cₖ₊₁\tilde{X}_{k+1|k}−Hₖ₊₁^{u}\hat{f}_{k+1|k+1}^{u}) (21)

where, Kₖ₊₁ is a Kalman gain matrix;

$$\begin{matrix}{K}_{k + 1} = {{P}^{⋒}}_{k + 1 \vert k}^{X} {{C}_{k + 1}^{T} ( {C}_{k + 1} {\tilde{P}}_{k + 1 \vert k}^{X} {C}_{k + 1}^{T} + {R}_{k + 1} )}^{- 1} & ( 22 ) \\ {{P}^{⋒}}_{k + 1 \vert k}^{X} = [ \begin{matrix}{A}_{k} & {B}_{k}\end{matrix} ] [ \begin{matrix}{\hat{P}}_{k \vert k}^{X} & {\hat{P}}_{k \vert k}^{X f} \\ {\hat{P}}_{k \vert k}^{fZ} & {\hat{P}}_{k \vert k}^{f}\end{matrix} ] [ \begin{matrix}{A}_{k}^{T} \\ {B}_{k}^{T}\end{matrix} ] + {Q}_{k} & ( 23 )\end{matrix}$$

By minimizing the observation equation, the unknown external excitation \hat{f}_{k+1|k+1}^{u} is obtained:

\hat{f}_{k+1|k+1}^{u}=Mₖ₊₁[yₖ₊₁−Cₖ₊₁(Aₖ\hat{X}_{k|k}+Bₖ\hat{f}_{k|k}^{u})] (24)

where

Mₖ₊₁=[(Cₖ₊₁Gₖ₊₁+Hₖ₊₁^{u})^{T}Rₖ₊₁⁻¹(I−Cₖ₊₁Kₖ₊₁)(Cₖ₊₁Gₖ₊₁+Kₖ₊₁^{u})]⁻¹(Cₖ₊₁Gₖ₊₁+Hₖ₊₁^{u})^{T}Rₖ₊₁⁻¹(I−Cₖ₊₁Kₖ₊₁ (25)

where, I is an identity matrix.

The GKF-UI method identifies f^{u}(t) in real time by observing a partial response. f^{u}=[f^{r}(t) g^{r}(t) f^{non}(t)]^{T}, so that the required nonlinear force generated by the vibration reduction/seismic isolation device, the interaction force between the substructures and the unknown external excitation can be identified.

Based on the above method of the present disclosure, the technical effects are numerically verified as follows.

(1) Numerical verification of seismic isolation bearing identification

A superstructure adopted was a 9-story shear frame, an El-Centro seismic wave was used as a seismic action, and a Bouc-Wen nonlinear model of hysteresis was used to simulate a force-deformation relationship of the seismic isolation bearing. The Bouc-Wen nonlinear model of hysteresis expressed a restoring force of the seismic isolation bearing as:

$$\begin{matrix} {R}_{b}^{Bouc - Wen} = {α}_{b} {k}_{b} {x}_{b} + ( 1 - {α}_{b} ) {k}_{b} {z}_{b}^{Bouc - Wen} & ( 26 ) \\ {\dot{z}}_{b}^{Bouc - Wen} = {\dot{x}}_{b} - \{ {β}_{b} \vert {\dot{x}}_{b} \vert {\vert {z}_{b}^{Bouc - Wen} \vert}^{{n}_{b} - 1} {z}_{b}^{Bouc - Wen} + {γ}_{b} {\dot{x}}_{b} {\vert {z}_{b}^{Bouc - Wen} \vert}^{{n}_{b}} \} & ( 27 )\end{matrix}$$

Structural parameters of a seismic isolation layer: lumped mass of the seismic isolation layer m_{b}=65 kg initial stiffness k_{b}=10×10⁵ N/m, and viscous damping coefficient c_{b}=800 N·s/m Parameters of the superstructure: element lumped mass mᵢ=60 kg, element linear stiffness kᵢ=1.2×10⁵ N/m, and element viscous damping coefficient cᵢ=1000 N·s/m (i=1,2, . . . , 9) Parameters of the Bouc-Wen nonlinear model of hysteresis: α_{b}=0.1, β_{b}=2000, γ_{b}=2000, n_{b}=1.25.

The results of the GEKF-UI in step 1 are shown in Table 1:

TABLE 1
Identification results of linear parameters of structure and damper

| Stiff- | | Iden- | | | | Iden- | |
|---|---|---|---|---|---|---|---|
| ness | Actual | tified | Error | Damping | Actual | tified | Error |
| (kN/m) | Value | Value | (%) | (N · s/m) | Value | Value | (%) |
| K_{b} | 100 | 100.00 | 0.00 | c_{b} | 800 | 809 | 1.18 |
| k₁ | 120 | 120.00 | 0.00 | c₁ | 1000 | 985 | −1.48 |
| k₂ | 120 | 120.06 | 0.05 | c₂ | 1000 | 1012 | 1.17 |
| k₃ | 120 | 119.92 | −0.06 | c₃ | 1000 | 986 | −1.42 |
| k₄ | 120 | 120.08 | 0.06 | c₄ | 1000 | 1008 | 0.79 |
| k₅ | 120 | 119.92 | −0.06 | c₅ | 1000 | 991 | −0.92 |
| k₆ | 120 | 120.04 | 0.04 | c₆ | 1000 | 1005 | 0.50 |
| k₇ | 120 | 119.95 | −0.04 | c₇ | 1000 | 992 | −0.77 |
| k₈ | 120 | 120.04 | 0.03 | c₈ | 1000 | 1006 | 0.59 |
| k₉ | 120 | 119.81 | −0.16 | c₉ | 1000 | 984 | −1.56 |

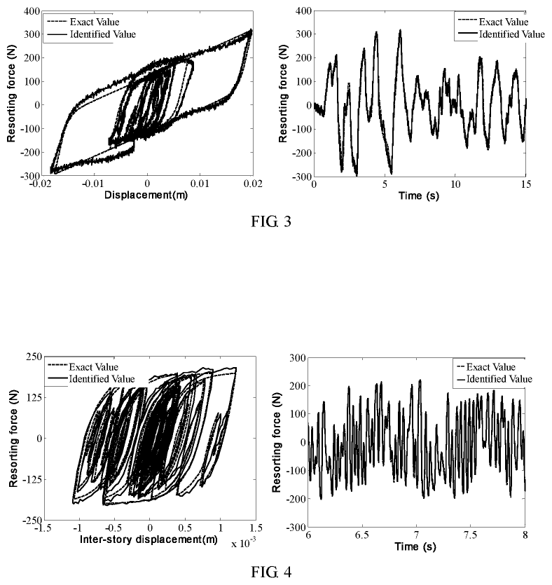

The results of the GKF-UI in step 2 are shown in FIG. 3. FIG. 3 shows a comparison of numerical results of nonlinear force identification of the seismic isolation device.

(2) Numerical Verification of Vibration Damper Identification

A model of a 10-story shear frame was externally excited by a white noise acting on a 9^{th} story. A vibration damper was installed between 8^{th} and 9^{th} stories. A Dahl nonlinear model was used to simulate a force-deformation relationship of the damper, which is expressed as follows:

F_{Dahl}(t)=k^{mr}Δxᵢ(t)+c^{mr}Δ\dot{x}ᵢ(t)+f_{d}zᵢ^{Dahl}(t)+f₀ (28)

Structural parameters: element lumped mass mᵢ=60 kg, element linear stiffness kᵢ=1.2×10⁵ N/m, (i=1,2, . . . , 10); structural damping C=αM₀+βK which is Rayleigh damping; first and second-order damping ratios ξ=0.3; damping coefficient α=0.3002, β=0.002257; and mass of the damper m^{mr}=2 kg Nonlinear model parameters of the damper: k^{mr}=4×10⁴ N/m, c^{mr}=100 N·s/m, f_{d}=200 N, f₀=0, σ=4000 s/m.

The results of the GEKF-UI in step 1 are shown in Tables 2 and 3:

TABLE 2
Identification results of linear parameters of structure

| | | | | Structural | | | |
|---|---|---|---|---|---|---|---|
| Structural Stiffness | Actual | Identified | Error | Damping | Actual | Identified | Error |
| (KN/m) | Value | Value | (%) | Coefficient | Value | Value | (%) |
| k₁ | 120 | 119.33 | −0.56 | α | 0.3002 | 0.2963 | −1.30 |
| k₂ | 120 | 119.80 | −0.16 | β | 0.002257 | 0.002340 | 3.70 |
| k₃ | 120 | 120.12 | 0.10 | | | | |
| k₄ | 120 | 120.11 | 0.09 | | | | |
| k₅ | 120 | 119.90 | −0.08 | | | | |
| k₆ | 120 | 120.25 | 0.21 | | | | |
| k₇ | 120 | 120.10 | 0.09 | | | | |
| k₈ | 120 | 120.04 | 0.03 | | | | |
| k₉ | 120 | 124.80 | 4.00 | | | | |
| k₁₀ | 120 | 120.89 | 0.75 | | | | |

TABLE 3
Identification results of linear parameters of damper

| Stiffness of | | | | Damping | | | |
|---|---|---|---|---|---|---|---|
| Damper | Actual | Identified | | of Damper | Actual | Identified | |
| (kN/m) | Value | Value | Error (%) | (N · s/m) | Value | Value | Error (%) |
| k^{mr} | 40 | 36.32 | −9.20 | c^{mr} | 100 | 104.75 | 4.75 |

The results of the GKF-UI in step 2 are shown in FIG. 4. FIG. 4 shows a comparison of numerical results of nonlinear force identification of the vibration reduction device.

Based on the above method of the present disclosure, the technical effects are experimentally verified as follows.

(1) Experimental Verification of Seismic Isolation Bearing Identification

Experimental data provided by Professor Satish Nagarajaiah of Rice University in the United States were used to identify a nonlinear force generated by a three-story experimental shear frame equipped with a negative stiffness damper (NSD) on a first story under an earthquake action.

A known element lumped mass was mᵢ=8.6 kips (i=1,2,3). A structural initial linear element stiffness was identified by an extended Kalman filter (EKF) as k₁=8.9041 kip/in, k₂=14.0061 kip/in, k₃=17.9544 kip/in and a damping coefficient was identified as α=0.5202, β=0.0017. The identification results of the linear physical parameters were used to identify a nonlinear force of the NSD.

A hysteresis loop of the nonlinear force of the NSD was identified by the GKF-UI, as shown in FIG. 5. FIG. 5 shows a comparison of experimental results of hysteresis loop identification of the nonlinear force of the NSD.

(2) Experimental Verification of Vibration Damper Identification

A five-story shear frame structure equipped with a magneto-rheological (MR) damper was experimented. An electromagnetic exciter acted on a 3^{rd} story of the structure, and continuously excited for 6 s, with a sampling frequency of 1,000 Hz.

The results of the GEKF-UI in step 1 are shown in Table 4:

TABLE 4
Identification results of linear parameters of structure

| | | | | Structural | | | |
|---|---|---|---|---|---|---|---|
| Structural Stiffness | Actual | Idntified | Error | Damping | Actual | Identified | Error |
| (kN/m) | Value | Value | (%) | Coefficient | Value | Value | (%) |
| k1 | 128.43 | 131.1 | 2.05 | α | 0.14 | 0.1335 | −4.6 |
| k2 | 138.49 | 139.7 | 0.92 | β | 6.8*10\hat{ } | 6.3*10\hat{ } | −7.3 |
| | | | | | −6 | −6 | |
| k3 | 129.34 | 134.3 | 3.82 | | | | |
| k4 | 126.72 | 120.2 | −5.14 | | | | |
| k5 | 126.96 | 122.4 | −3.57 | | | | |

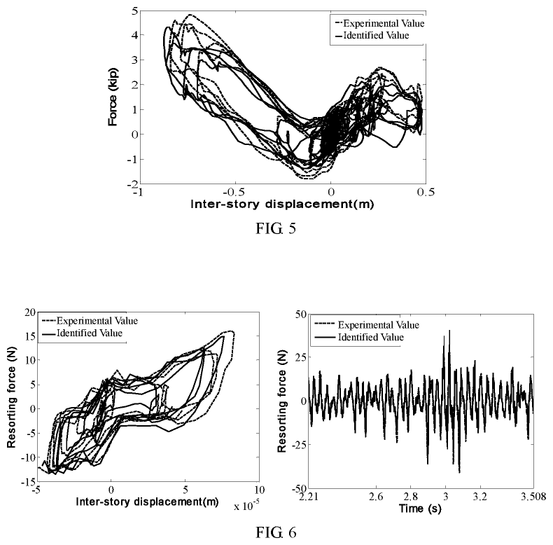

The results of the GKF-UI in step 2 are shown in FIG. 6. FIG. 6 shows a comparison of experimental results of nonlinear force identification of the vibration reduction device.

In the description of this specification, the description of the terms “one embodiment/implementation”, “some embodiments/implementations”, “example”, “specific example” and “some examples” etc. means that the specific features, structures, materials or characteristics described with reference to the embodiment/implementation or example are included in at least one embodiment/implementation or example of the present application. In this specification, the illustrative expressions of the above terms are not intended to refer to the same embodiment/implementation or example. Moreover, the specific features, structures, materials or characteristics described may be combined in any suitable manner in any one or more embodiments/implementations or examples. In addition, those skilled in the art may combine different embodiments/implementations or examples described herein or features in different embodiments/implementations or examples without any contradiction.

Those skilled in the art should understand that the foregoing implementations are merely intended to describe the present disclosure clearly, rather than to limit the scope of the present disclosure. Those skilled in the art may make other changes or modifications based on the foregoing disclosure, but these changes or modifications should fall within the scope of the present disclosure.

1. A real-time identification method for a nonlinear characteristic of a model-free in-service seismic isolation/vibration reduction device driven based on monitoring data, comprising:
dividing a structure of a seismic isolation/vibration reduction system into a plurality of substructures, and defining a substructure where the seismic isolation/vibration reduction device is located as a target substructure; and
using a General Extended Kalman filter with unknown inputs (GEKF-UI) to identify a linear stiffness and a damping coefficient of the seismic isolation/vibration reduction device and a linear stiffness and a damping coefficient of the target substructure, in the case that an external excitation on the seismic isolation/vibration reduction device is small so that the seismic isolation/vibration reduction system is in a linear state.

2. The method according to claim 1, wherein the method further comprises:
using a General Kalman filter with unknown inputs (GKF-UI) to identify a nonlinear restoring force received by the target substructure by the linear stiffness and the damping coefficient of the seismic isolation/vibration reduction device and the linear stiffness and the damping coefficient of the target substructure, in the case that the external excitation on the seismic isolation/vibration reduction device is large so that the seismic isolation/vibration reduction device generates a nonlinear force.

3. The method according to claim 1, wherein in the case that the external excitation on the seismic isolation/vibration reduction device is small so that the seismic isolation/vibration reduction system is in a linear state, a motion equation of the target substructure is:
M^{r}\ddot{x}^{r}(t)+(C^{r}+C′)\dot{x}^{r}(t)+(K^{r}+K′)x^{r}(t)=η^{r}f^{r}(t)+η^{g}f^{g}(t)=η^{u}f^{u}(t)
wherein, M^{r}, C^{r} and K^{r} are mass, damping and stiffness matrices of the target substructure, respectively; \ddot{x}^{r}(t), \dot{x}^{r}(t) and x^{r}(t) are acceleration, velocity and displacement vectors of the target substructure, respectively; f^{r}(t) is the external excitation received by the target substructure; f^{g}(t) is a force of an adjacent substructure on the target substructure; η^{r} and η^{g} are position matrices of the external excitation and the force; C′ and K′ are additional damping and stiffness provided by the seismic isolation/vibration reduction device to the system structure; η^{u} is a position matrix of the external excitation f^{u}(t).

4. The method according to claim 3, wherein in the case that the external excitation on the seismic isolation/vibration reduction device is small so that the seismic isolation/vibration reduction system is in a linear state, an extended vector Z=[x^{T} \dot{x}^{T} θ^{T}]^{T} is established, and the GEKF-UI is used to obtain θ to express the linear stiffness and the damping coefficient of the seismic isolation/vibration reduction device and the linear stiffness and the damping coefficient of the target substructure.

5. The method according to claim 2, wherein in the case that the external excitation on the seismic isolation/vibration reduction device is large so that the seismic isolation/vibration reduction device generates a nonlinear force, a motion equation of the target substructure is:
M^{r}\ddot{x}^{r}(t)+C^{r}\dot{x}^{r}(t)+K^{r}x^{r}(t)=η^{r}f^{r}(t)+η^{g}g^{r}(t)−η^{non}f^{non}(t)=η^{u}f^{u}(t)
wherein C^{r} and K^{r} are identified values in the case that the external excitation on the seismic isolation/vibration reduction device is small so that the seismic isolation/vibration reduction system is in a linear state; the GKF-UI is used to identify f^{u}(t) by observing a response of a partial structure; the nonlinear force generated by the vibration reduction/seismic isolation device is identified based on the identified f^{u}(t) and f^{u}=[f^{r}(t) g^{r}(t) f^{non}(t)]^{T}.

6. A real-time identification device for a nonlinear characteristic of a model-free in-service seismic isolation/vibration reduction device driven based on monitoring data, comprising:
a dividing module, for dividing a structure of a seismic isolation/vibration reduction system into a plurality of substructures, and defining a substructure where the seismic isolation/vibration reduction device is located as a target substructure; and
a GEKF-UI identification module, for using a GEKF-UI to identify a linear stiffness and a damping coefficient of the seismic isolation/vibration reduction device and a linear stiffness and a damping coefficient of the target substructure based on monitoring data, in the case that an external excitation on the seismic isolation/vibration reduction device is small so that the seismic isolation/vibration reduction system is in a linear state.

7. The device according to claim 6, wherein the device further comprises:
a GKF-UI identification module, for using a GKF-UI to identify a nonlinear restoring force received by the target substructure by the linear stiffness and the damping coefficient of the seismic isolation/vibration reduction device and the linear stiffness and the damping coefficient of the target substructure identified by the GEKF-UI identification module, in the case that the external excitation on the seismic isolation/vibration reduction device is large so that the seismic isolation/vibration reduction device generates a nonlinear force.

8. The device according to claim 6, wherein in the case that the external excitation on the seismic isolation/vibration reduction device is small so that the seismic isolation/vibration reduction system is in a linear state, a motion equation of the target substructure is:
M^{r}\ddot{x}^{r}(t)+(C^{r}+C′)\dot{x}^{r}(t)+(K^{r}+K′)x^{r}(t)=η^{r}f^{r}(t)+η^{g}f^{g}(t)=η^{u}f^{u}(t)
wherein, M^{r}, C^{r} and K^{r} are mass, damping and stiffness matrices of the target substructure, respectively; \ddot{x}^{r}(t), \dot{x}^{r}(t) and x^{r} (t) are acceleration, velocity and displacement vectors of the target substructure, respectively; f^{r}(t) is the external excitation received by the target substructure; f^{g}(t) is a force of an adjacent substructure on the target substructure; η^{r} and η^{g} are position matrices of the external excitation and the force; C′ and K′ are additional damping and stiffness provided by the seismic isolation/vibration reduction device to the system structure; η^{u} is a position matrix of the external excitation f^{u}(t);
an extended vector Z=[x^{T} \dot{x}^{T} θ^{T}]^{T} is established, and the GEKF-UI is used to obtain θ to express the linear stiffness and the damping coefficient of the seismic isolation/vibration reduction device and the linear stiffness and the damping coefficient of the target substructure.

9. The device according to claim 6, wherein in the case that the external excitation on the seismic isolation/vibration reduction device is large so that the seismic isolation/vibration reduction device generates a nonlinear force, a motion equation of the target substructure is:
M^{r}\ddot{x}^{r}(t)+C^{r}\dot{x}^{r}(t)+K^{r}x^{r}(t)=η^{r}f^{r}(t)+η^{g}g^{r}(t)−η^{non}f^{non}(t)=η^{u}f^{u}(t),
wherein C^{r} and K^{r} are identified values in the case that the external excitation on the seismic isolation/vibration reduction device is small so that the seismic isolation/vibration reduction system is in a linear state; the GKF-UI is used to identify f^{u}(t) by observing a response of a partial structure; the nonlinear force generated by the vibration reduction/seismic isolation device is identified based on the identified f^{u}(t) and f^{u}=[f^{r}(t) g^{r}(t) f^{non}(t)]^{T}.

10. The device according to claim 7, wherein in the case that the external excitation on the seismic isolation/vibration reduction device is small so that the seismic isolation/vibration reduction system is in a linear state, a motion equation of the target substructure is:
M^{r}\ddot{x}^{r}(t)+(C^{r}+C′)\dot{x}^{r}(t)+(K^{r}+K′)x^{r}(t)=η^{r}f^{r}(t)+η^{g}f^{g}(t)=η^{u}f^{u}(t)
wherein, M^{r}, C^{r} and K^{r} are mass, damping and stiffness matrices of the target substructure, respectively; \ddot{x}(t), \dot{x}^{r}(t) and x^{r}(t) are acceleration, velocity and displacement vectors of the target substructure, respectively; f^{r}(t) is the external excitation received by the target substructure; f^{g}(t) is a force of an adjacent substructure on the target substructure; η^{r} and η^{g} are position matrices of the external excitation and the force; C′ and K′ are additional damping and stiffness provided by the seismic isolation/vibration reduction device to the system structure; η^{u} is a position matrix of the external excitation f^{u}(t);
an extended vector Z=[x^{T} \dot{x}^{T} θ^{T}]^{T} is established, and the GEKF-UI is used to obtain θ to express the linear stiffness and the damping coefficient of the seismic isolation/vibration reduction device and the linear stiffness and the damping coefficient of the target substructure.

11. The device according to claim 7, wherein in the case that the external excitation on the seismic isolation/vibration reduction device is large so that the seismic isolation/vibration reduction device generates a nonlinear force, a motion equation of the target substructure is:
M^{r}\ddot{x}^{r}(t)+C^{r}\dot{x}^{r}(t)+K^{r}x^{r}(t)=η^{r}f^{r}(t)+η^{g}g^{r}(t)−η^{non}f^{non}(t)=η^{u}f^{u}(t)
wherein C^{r} and K^{r} are identified values in the case that the external excitation on the seismic isolation/vibration reduction device is small so that the seismic isolation/vibration reduction system is in a linear state; the GKF-UI is used to identify f^{u}(t) by observing a response of a partial structure; the nonlinear force generated by the vibration reduction/seismic isolation device is identified based on the identified f^{u}(t) and f^{u}=[f^{r}(t) g^{r}(t) f^{non}(t)]^{T}.

12. The method according to claim 2, wherein in the case that the external excitation on the seismic isolation/vibration reduction device is small so that the seismic isolation/vibration reduction system is in a linear state, a motion equation of the target substructure is:
M^{r}\ddot{x}^{r}(t)+(C^{r}+C′)\dot{x}^{r}(t)+(K^{r}+K′)x^{r}(t)=η^{r}f^{r}(t)+η^{g}f^{g}(t)=η^{u}f^{u}(t)
wherein, M^{r}, C^{r} and K^{r} are mass, damping and stiffness matrices of the target substructure, respectively; \ddot{x}(t), \dot{x}^{r}(t) and x^{r} (t) are acceleration, velocity and displacement vectors of the target substructure, respectively; f^{r}(t) is the external excitation received by the target substructure; f^{g}(t) is a force of an adjacent substructure on the target substructure; η^{r} and η^{g} are position matrices of the external excitation and the force; C′ and K′ are additional damping and stiffness provided by the seismic isolation/vibration reduction device to the system structure; η^{u} is a position matrix of the external excitation f^{u}(t).

13. The method according to claim 12, wherein in the case that the external excitation on the seismic isolation/vibration reduction device is small so that the seismic isolation/vibration reduction system is in a linear state, an extended vector Z=[x^{T} \dot{x}^{T} θ^{T}]^{T} is established, and the GEKF-UI is used to obtain θ to express the linear stiffness and the damping coefficient of the seismic isolation/vibration reduction device and the linear stiffness and the damping coefficient of the target substructure.

14. The method according to claim 13, wherein in the case that the external excitation on the seismic isolation/vibration reduction device is large so that the seismic isolation/vibration reduction device generates a nonlinear force, a motion equation of the target substructure is:
M^{r}\ddot{x}^{r}(t)+C^{r}\dot{x}^{r}(t)+K^{r}x^{r}(t)=η^{r}f^{r}(t)+η^{g}g^{r}(t)−η^{non}f^{non}(t)=η^{u}f^{u}(t)
wherein C^{r} and K^{r} are identified values in the case that the external excitation on the seismic isolation/vibration reduction device is small so that the seismic isolation/vibration reduction system is in a linear state; the GKF-UI is used to identify f^{u}(t) by observing a response of a partial structure; the nonlinear force generated by the vibration reduction/seismic isolation device is identified based on the identified f^{u}(t) and f^{u}=[f^{r}(t) g^{r}(t) f^{non}(t)]^{T}.

15. The method according to claim 4, wherein in the case that the external excitation on the seismic isolation/vibration reduction device is large so that the seismic isolation/vibration reduction device generates a nonlinear force, a motion equation of the target substructure is:
M^{r}\ddot{x}^{r}(t)+C^{r}\dot{x}^{r}(t)+K^{r}x^{r}(t)=η^{r}f^{r}(t)+η^{g}g^{r}(t)−η^{non}f^{non}(t)=η^{u}f^{u}(t)
wherein C^{r} and K^{r} are identified values in the case that the external excitation on the seismic isolation/vibration reduction device is small so that the seismic isolation/vibration reduction system is in a linear state; the GKF-UI is used to identify f^{u}(t) by observing a response of a partial structure; the nonlinear force generated by the vibration reduction/seismic isolation device is identified based on the identified f^{u}(t) and f^{u}=[f^{r}(t) g^{r}(t) f^{non}(t)]^{T}.
